(19) United States
(12) Patent Application Publication
(10) Pub. No.: US 2025/0232414 A1
(43) Pub. Date: Jul. 17, 2025

(54) MEDICAL IMAGE DENOISING BASED ON LAYER SEPARATION

(71) Applicant: Shanghai United Imaging Intelligence Co., Ltd., Shanghai (CN)

(72) Inventors: Yikang Liu, Cambridge, MA (US); Zhang Chen, Brookline, MA (US); Xiao Chen, Lexington, MA (US); Shanhui Sun, Lexington, MA (US); Terrence Chen, Lexington, MA (US)

(73) Assignee: Shanghai United Imaging Intelligence Co., Ltd., Shanghai (CN)

(21) Appl. No.: 18/412,887

(22) Filed: Jan. 15, 2024

(51) Int. Cl. G06T 5/70; G06T 5/20; G06T 5/60; G06T 7/00; G06T 7/187; G06T 7/194

(52) U.S. Cl. CPC G06T 5/70; G06T 5/20; G06T 5/60; G06T 7/0014; G06T 7/187; G06T 7/194; G06T 2207/10121; G06T 2207/20081; G06T 2207/20084; G06T 2207/30021; G06T 2207/30048; G06T 2207/30061; G06T 2207/30101

(57) ABSTRACT

Disclosed herein are systems, methods, and instrumentalities associated with medical image denoising. An apparatus configured to perform the medical image denoising task may be configured to obtain a medical image of an object and separate the medical image into a background layer and a foreground layer. The apparatus may then denoise the background layer using a first neural network pre-trained to suit the characteristics of the background layer, denoise the foreground layer using a second neural network pre-trained to suit the characteristics of the foreground layer, and merge the denoised background layer and the denoised foreground layer back into a clean medical image that depicts the object with improved image quality.

### BACKGROUND

Medical imaging including X-rays, magnetic resonance imaging (MRI), computer tomography (CT), ultrasound, etc. is susceptible to noise that may be caused by hardware limitations, patient movements, and/or environmental factors. This may be especially true for real-time imaging such as X-ray fluoroscopy. Therefore, denoising plays a crucial role in the realm of medical imaging by improving the quality and reliability of images used for diagnosis, treatment planning, and research, contributing to more accurate assessments, enhanced visibility of a target object, and support for various medical applications that may rely on clear and detailed images. Deep learning based techniques may yield state-of-the-art performance in denoising, but real-time denoising with deep learning is difficult due to computation complexity and hardware costs that may be involved.

### SUMMARY

Disclosed herein are systems, methods, and instrumentalities associated with medical image denoising. According to embodiments of the disclosure, an apparatus configured to perform the medical image denoising task may include one or more processors that may be configured to obtain a medical image of an object (e.g., as part of a fluoroscopy video of the object), and denoise the medical image, wherein, during the denoising, the one or more processors may be configured to separate the medical image into a background layer and a foreground layer, denoise the background layer using a first neural network, and denoise the foreground layer using a second neural network. The second neural network may differ from the first neural network with respect to at least one of a neural network architecture or a number of neural network parameters. The one or more processors may then merge the denoised background layer and the denoised foreground layer into a denoised medical image that depicts the object.

In some embodiments, the medical image may be separated into a background layer and a foreground layer using a third neural network, wherein the third neural network may be trained using training data generated via recursive projected compressive sensing.

In some embodiments, the first neural network used to denoise the background layer of the medical image may be a convolutional neural network (CNN) and the second neural network used to denoise the foreground layer of the medical image may be a multi-layer perceptron (MLP) neural network, wherein denoising the foreground layer of the medical image using the second neural network may include dissecting the foreground layer into multiple patches and denoising the multiple patches using the MLP neural network.

In some embodiments, the first neural network used to denoise the background layer of the medical image may include a smaller number of neural network parameters than the second neural network used to denoise the foreground layer of the medical image.

In some embodiments, the denoised background layer and the denoised foreground layer may be merged into the denoised medical image using a third neural network that may be trained jointly with the first neural network and the second neural network.

In some embodiments, the first neural network and the second neural network may be jointly trained (e.g., with or without the third neural network) via a training process during which the first neural network may be used to denoise a background training image comprising first synthetic noise and the second neural network may be used to denoise a foreground training image comprising second synthetic noise. The parameters of the first neural network may be adjusted based on a difference between the denoised background training image and a clean ground truth background image, while the parameters of the second neural network may be adjusted based on a difference between the denoised foreground training image and a clean ground truth foreground image. In addition, the denoised foreground training image and the denoised background training image may be merged into a denoised image, and the respective parameters of the first neural network and the second neural network may be further adjusted based on a difference between the denoised image and a clean ground truth image. In some embodiments, the respective parameters of the first neural network and the second neural network may be learned in an unsupervised manner based on medical training images that may comprise real noise.

### BRIEF DESCRIPTION OF THE DRAWINGS

A more detailed understanding of the examples disclosed herein may be had from the following description, given by way of example in conjunction with the accompanying drawing.

FIG. 1 is a simplified block diagram illustrating example operations that may be associated with medical image denoising according to one or more embodiments of the present disclosure.

FIG. 2 is a simplified block diagram illustrating an example of denoising a medical image using multiple different neural networks according to one or more embodiments of the present disclosure.

FIG. 3 is a simplified block diagram illustrating an example of separating a medical image into a background layer and a foreground layer using a pre-trained neural network according to one or more embodiments of the present disclosure.

FIG. 4 is a simplified diagram illustrating an example of merging a background layer and a foreground layer into a medical image according to one or more embodiments of the present disclosure.

FIG. 5 is a simplified flow diagram illustrating an example process for training an artificial neural network to perform one or more of the tasks described in embodiments of the present disclosure.

FIG. 6 is a simplified block diagram illustrating example components of an apparatus that may be configured to perform an image denoising task according to one or more embodiments of the present disclosure.

### DETAILED DESCRIPTION

Disclosed herein are deep learning (DL) based techniques that may be used to facilitate the denoising of medical images such as magnetic resonance (MR) images, X-ray images, computed tomography (CT) images, photoacoustic tomography (PAT) images, etc. The disclosure is illustrated by way of example, and not by way of limitation, in the figures of the accompanying drawings. A detailed description of illustrative embodiments will now be provided with reference to these figures. Although the embodiments may be described with certain technical details, it should be noted that the details are not intended to limit the scope of the disclosure.

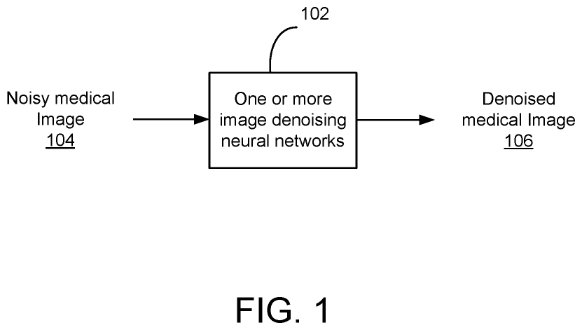

Noise in medical images may obscure important anatomical structures or surgically placed medical devices, making it challenging for clinicians to identify abnormalities. FIG. 1 illustrates example operations that may be associated with medical image denoising. As illustrated in FIG. 1, one or more image denoising neural networks 102 may be trained to denoise a noisy medical image 104 of an object and obtain a denoised image 106 of the object with improved quality over the noisy image received at the input (e.g., with respect to one or more of subtle details, noise levels, aliasing effect, blurriness, etc.). Noisy medical image 104 may be any of an MR image, an X-ray image (e.g., as part of an X-ray video acquired via fluoroscopy imaging), a CT image, a PAT image, etc., and the object depicted in the image may be any anatomical structure of the human body (e.g., heart, blood vessels, etc.) or a medical device placed inside the human body (e.g., stent, guidewire, catheter, etc.). Since noisy medical imaging 104 may include dense imagery information, denoising such an image (e.g., as part of denoising a medical video) using traditional techniques may be time consuming to the degree of affecting the effectiveness of real-time medical imaging in clinical practice. To accelerate the denoising operation and/or to improve the quality of the resulting image, the one or more image denoising neural networks 102 may be configured to separate the noisy medical image 104 into a foreground layer and a background layer, and denoise the foreground layer and the background layer based on respective machine learning (ML) models implemented via different neural networks. The denoised foreground layer and background layer may then be merged back together to obtain a denoised image (e.g., denoised image 106) that may provide a higher quality depiction of the object captured in noisy medical image 104.

As will be described in greater detail below, the background layer of noisy medical image 104 may be a low-ranked, dense layer with slow changes, while the foreground layer of noisy medical image 104 may be a high-ranked, sparse layer with fast changes (e.g., the background layer may be lower-ranked than the foreground layer because the background may contain less information than the foreground layer). Accordingly, embodiments of the present disclosure contemplate using a first neural network to denoise the background and using a second neural network to denoise the foreground. The first neural network may differ from the second neural network with respect to the respective neural network architecture employed by each neural network and/or the respective number of neural network parameters (e.g., neural network layers) used by each neural network. For example, the first neural network used to denoise the background layer may be a convolutional neural network (CNN), while the second neural network used to denoise the foreground layer may be a multi-layer perception (MLP) neural network. As another example, the first neural network used to denoise the background layer and the second neural network used to denoise the foreground layer may employ the same neural network architecture (e.g., both may be CNNs), but the first neural network may include a smaller number of neural network parameters (e.g., a smaller number of layers) than the second neural network. This way, the overall performance of the denoising operation may be improved (e.g., in terms of the overall time it takes to generate the denoised image 106) compared to using a single neural network to denoise the image (or a video comprising the image) as a whole.

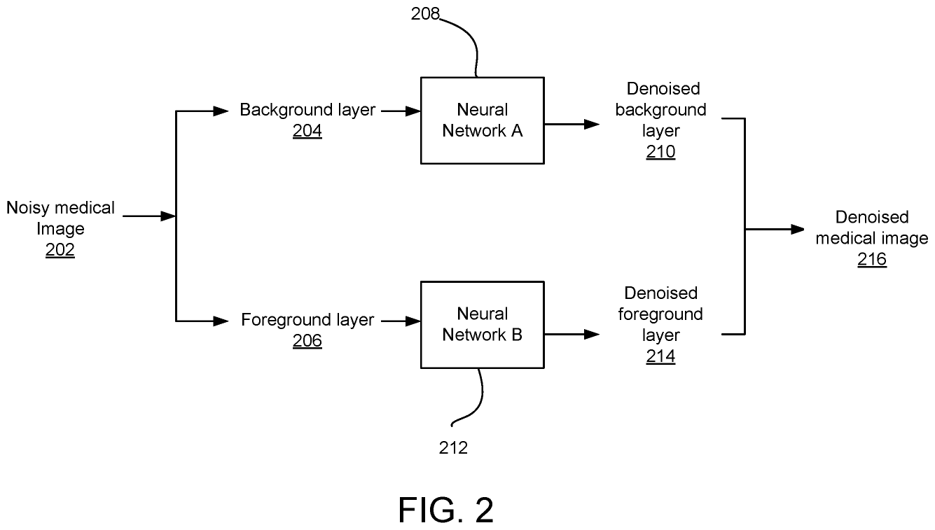

FIG. 2 illustrates example operations that may be associated with denoising a medical image based on a foreground layer of the medical image and a background layer of the medical image. As illustrated in FIG. 2, a noisy medical image 202 (e.g., noisy medical image 104 of FIG. 1) may be separated into a background layer 204 and a foreground layer 206. A first image denoising neural network 208 (e.g., which may also be referred to herein as neural network A) may be trained to denoise the background layer 204 to derive a denoised background layer 210. A second image denoising neural network 212 (e.g., which may also be referred to herein as neural network B) may be trained to denoise the foreground layer 206 to derive a denoised foreground layer 214. The denoised background layer 210 and the denoised foreground layer 214 may then be merged into a denoised medical image 216.

In some embodiments, medical image 202 may be separated into background layer 204 and foreground layer 206 using various layer separation techniques such as, e.g., color-based, depth-based, or pixel affinity-based layer separation techniques, while in other embodiments medical image 202 may be separated into background layer 204 and foreground layer 206 using a pre-trained neural network, which will be described in greater detail below.

In some embodiments, neural network 208 may be a faster and/or weaker neural network compared to neural network 212 (e.g., neural network 212 may be slower but stronger than neural network 208). For example, neural network 208 and neural network 212 may employ the same neural network architecture (e.g., both may employ a convolutional neural network (CNN) architecture), but neural network 212 may include more layers (e.g., convolutional layers) and/or parameters (e.g., weights) than neural network 208. As another example, neural network 208 and neural network 212 may employ different neural network architectures that may be specifically suited for denoising background layer 204 and foreground layer 206, respectively. For instance, neural network 208 may include a CNN such as a CNN with a U-shaped architecture, while neural network 212 may include a multi-layer perceptron (MLP) neural network such as an MLP-mixer that may include a first set layers configured to apply the MLPs independently to image patches, and a second set of layers configured to apply the MLPs across image patches. The structural characteristics of the MLP mixer may make it more suitable (e.g., superior) for processing the sparse foreground layer 206 since the front layer may only reside in a portion of a field of view (FOV) and therefore may be dissected into a few patches (with fewer pixels than the entire image). In contrast, the structural characteristics of the CNN may make it more biased towards low frequency components of an image and thus better at handling a whole image such as the smoother background layer 204. In examples, the CNN may be given a smaller number of parameters, while the MLP may be given a larger number of parameters (e.g., the CNN may be slightly slower than the MLP if they are given the same number of parameters).

An example reason for using different neural networks to denoise background layer 204 and foreground 206 separately may be that the background layer may be a dense layer with slow changes (e.g., between different image frames of a video), while the foreground layer may be a sparse layer (e.g., suitable to be processed as image patches) with fast changes. As such, using a faster (and/or weaker) neural network to denoise the background layer and a slower (and/or stronger) neural network to denoise the foreground may improve the overall performance of the denoising operation (e.g., compared to using a single neural network to denoise image 202 as a whole without layer separation).

In examples, one or both of neural network 208 and neural network 212 may employ an encoder-decoder structure and/or may include a plurality of layers configured to extract features from an input image (e.g., background layer 204 or foreground layer 206). Based on the extracted features, neural network 208 and/or neural network 212 may learn a mapping from noisy images to clean images, effectively reducing or eliminating unwanted noise while preserving important image details. Using a CNN as an example, the CNN may include a plurality of convolutional layers, each of which may in turn include a plurality of convolution kernels or filters having respective weights (e.g., corresponding to the parameters of a ML model implemented through the CNN) that may be configured to extract features from an input image (e.g., background layer 204 or foreground layer 206). The convolution operations may be followed by batch normalization and/or an activation function (e.g., such as a rectified linear unit (ReLu) activation function), and the features extracted by the convolutional layers may be down sampled through one or more pooling layers and/or one or more fully connected layers to obtain a representation of the features, e.g., in the form of a feature map or a feature vector. In examples, the CNN may further include one or more un-pooling layers and one or more transposed convolutional layers. Through these un-pooling layers and/or transposed convolutional layers, the features extracted from the input image may be up-sampled and further processed (e.g., through a plurality of deconvolution operations) to derive an up-scaled or dense feature map or feature vector. The dense feature map or vector may then be used to predict a clean image corresponding to the noisy image received at the input.

In examples, one or both of neural network 208 and neural network 212 may employ a recurrent neural network (RNN) structure, a cascaded neural network structure, or another suitable type of neural network structures. An RNN may include an input layer, an output layer, a plurality of hidden layers (e.g., convolutional layers), and connections that feed hidden layers back into themselves (e.g., the connections may be referred to as recurrent connections). The recurrent connections may provide the RNN with the visibility of not only the current data sample that the RNN has been provided with, but also hidden states associated with previously processed data samples (e.g., the feedback mechanism of the RNN may be visualized as multiple copies of a neural network, with the output of one serving as an input to the next). As such, the RNN may use its understanding of past events to process a current input rather than starting from scratch every time.

In examples, neural network 208 and neural network 212 may be trained using paired noisy images (e.g., noisy foreground images or background images) and corresponding clean, ground truth images in a supervised manner. For instance, the noisy foreground or background training images may be generated by adding synthetic noise to clean and layer separated images (e.g., X-ray images acquired with relatively high dose or from skinny patients, natural images, etc.). The neural networks may be trained separately or jointly. In the case of separate training (e.g., the neural networks may be trained independently from each other), neural network 208 and neural network 212 may be used during their respective training processes to denoise a noisy background training image or a noisy foreground training image, and the respective parameters of the neural networks may be adjusted with an objective to minimize a difference (e.g., loss) between the denoised background/foreground image and the corresponding clean, layer separated ground truth image. In the case of joint training, neural network 208 may be used to denoise a noisy background training image and neural network 212 may be used to denoise a noisy foreground training image. The denoised background image and the denoised foreground image may then be combined (e.g., merged) to predict a clean image, and the respective parameters of the neural networks may be adjusted with an objective to minimize a difference (e.g., loss) between the predicted clean image and a ground truth clean image.

In examples, neural network 208 and/or neural network 212 may also be fine-tuned using a target dataset (e.g., dataset associated with a real application such as a fluoroscopy video of the lungs) based on one or more unsupervised losses. For example, during the training of neural network 208 and/or neural network 212, a training image may be randomly subsampled into two images, wherein corresponding pixels at the same location of the two subsampled images may be neighboring pixels in the original image. The fine-tuning may then be performed by using one of the subsampled images as an input and the other one of the subsampled images as a training target (or ground truth), since the neighboring pixels from the original image are expected to be similar to each other.

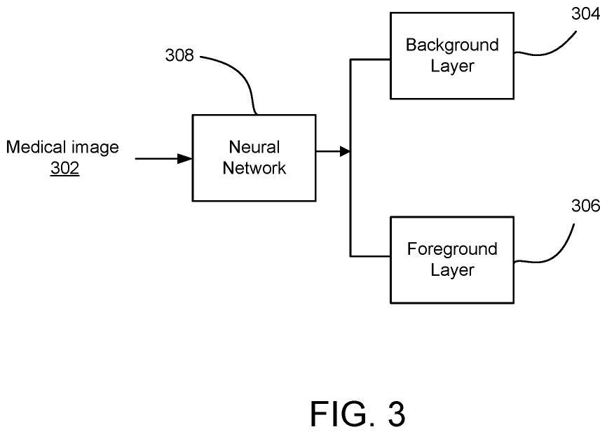

FIG. 3 illustrating an example of separating a medical image into different layers using a pre-trained neural network. As shown in FIG. 3, a medical image 302 (e.g., medical image 202 of FIG. 2) may be separated into a background layer 304 (e.g., background layer 204 in FIG. 2) and a foreground layer 306 (e.g., foreground layer 206 in FIG. 2) via a neural network 308. In examples, neural network 308 may include an input layer, an output layer, and a plurality of hidden layers (e.g., convolutional layers), which may be configured to extract features from medical image 302 and assign semantic labels (e.g., classification labels) to each pixel of the medical image that may indicate whether the pixel belongs to the foreground or the background of the medical image. In examples, neural network 308 may employ a U-Net architecture that may include a contracting path, which may capture context and reduce spatial resolution, followed by an expansive path that may recover localization information. Skip connections may be used to concatenate feature maps from the contracting path to the corresponding layers in the expansive path, the design of which may assist with preserving fine details during the layer separation.

Neural network 308 may provide the benefit of accomplishing (e.g., at an inference time) layer separation in real time based on a small buffer of images (e.g., based on a batch of five image frames from a medical video). In examples, neural network 308 may be trained using a dataset generated via conventional layer separation and/or reconstruction techniques. For instance, the data used to train neural network 308 may be generated via recursive projected compressive sensing (RPCS), which is an iterative approach that utilizes compressed sensing principles and recursion techniques to enhance layer separation and reconstruction of distinct components within an image (e.g., such as in scenarios involving sparse or low-rank representations). The training data may, for example, be generated by applying RPCS to a long video (e.g., a video comprising 100 or more frames or images) to separate the images into respective background images and foreground images, which may then be used as background training images and foreground training images for neural network 308. During the training, neural network 308 may be used to predict a background layer and a foreground layer based on an input training medical image from which ground truth foreground and background layers have been obtained via RPCS. The parameters of the neural network may then be adjusted based on a difference between the predicted background layer and/or foreground layer and the corresponding ground truth.

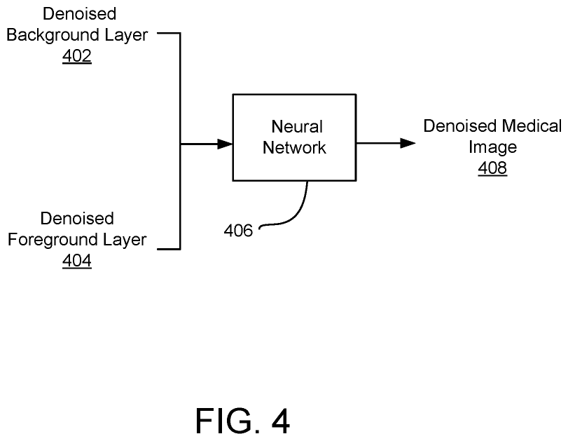

FIG. 4 illustrates an example of merging denoised foreground and background layers into a denoised medical image using a neural network. As shown in FIG. 4, a denoised background layer 402 (e.g., denoised background layer 210 in FIG. 2) and a denoised foreground layer 404 (e.g., background layer 214 in FIG. 2) may be merged into a denoised medical image 408 (e.g., denoised medical image 216 in FIG. 2) via a neural network 406. In examples, neural network 406 may include an input layer, an output layer, and a plurality of hidden layers (e.g., convolutional layers). Similar to one or more other neural networks described herein, neural network 406 may also follow an encoder-decoder architecture. The encoder may be configured to extract features from both the foreground and background images, and the decoder may be configured to combine these features to generate the merged image. Skip connections between corresponding encoder and decoder layers may be used to help preserve low-level details during the merging.

In examples, neural network 406 may be jointly trained with the layer denoising neural networks described herein based on non-layer-separated medical training images (e.g., from a medical training video). For instance, during the joint training, a noisy training image (e.g., with real or synthetic noise) may be separated into a background layer and a foreground using any of the techniques described herein. The background layer may be denoised using the background denoising neural network described herein (e.g., neural network 208 of FIG. 2) and the foreground layer may be denoised using the foreground denoising neural network described herein (e.g., neural network 212 of FIG. 2). The denoised background layer and the denoised foreground layer may be merged using neural network 406 to derive an estimated denoised image. The respective parameters of the background denoising neural network, foreground denoising neural network, and neural network 406 may then be adjusted based on a difference (e.g., loss) between the estimated denoised image and a ground truth clean image that corresponds to the input noisy training image.

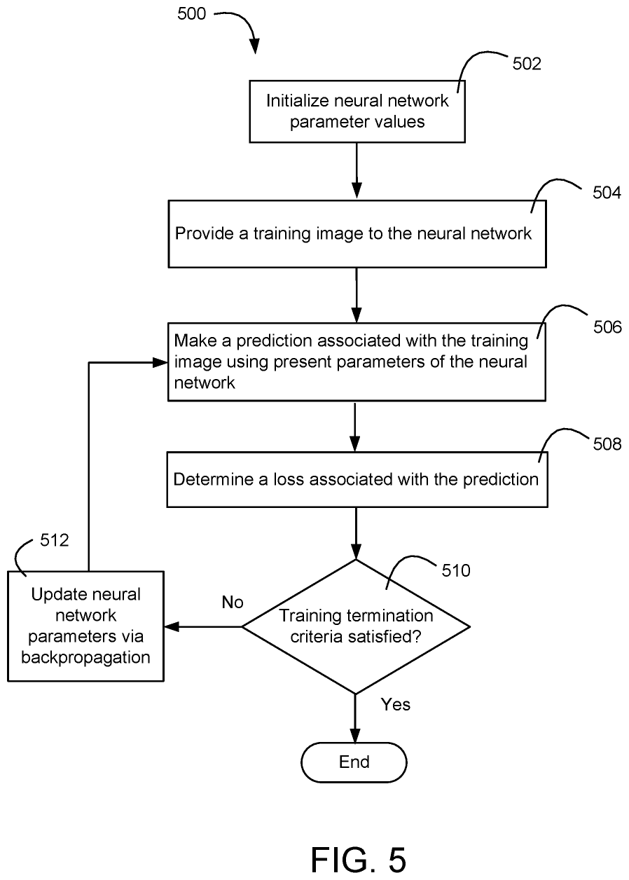

FIG. 5 illustrates example operations 500 associated with training an artificial neural network to perform one or more of the tasks described herein. As shown in FIG. 5, training operations 500 may include initializing the operating parameters of the neural network (e.g., weights associated with various layers of the neural network) at 502, for example, by sampling from a probability distribution or by copying the parameters of another neural network having a similar structure. The training operations may further include providing one or more first inputs (e.g., noisy medical images) to the neural network at 504 and causing the neural network to make a prediction (e.g., a denoised medical image) using presently assigned network parameters at 506.

At 508, a loss associated with the prediction may be determined, for example, based on the prediction made at 506 and a corresponding ground truth (e.g., a clean medical image). The loss may be calculated using various loss functions including, for example, a mean squared error (MSE) based loss function, an L1/L2 based loss function, a structural similarity index (SSIM) based loss function, etc. At 510, a determination of whether one or more training termination criteria have been satisfied may be made. For example, the training termination criteria may be satisfied if the loss between the ground truth and the prediction (e.g., a denoised image) is small enough (e.g., compared to a threshold value), if a pre-determined number of training iterations has been completed, or if a change in the loss between two training iterations falls below a predetermined threshold. If the determination at 510 is that the training termination criteria are satisfied, the training may end. Otherwise, the presently assigned network parameters may be adjusted at 512, for example, by backpropagating a gradient descent of the loss through the network, before the training returns to 506.

For simplicity of explanation, the training operations are depicted and described herein with a specific order. It should be appreciated, however, that the training operations may occur in various orders, concurrently, and/or with other operations not presented or described herein. Furthermore, it should be noted that not all operations that may be included in the training process are depicted and described herein, and not all illustrated operations are required to be performed.

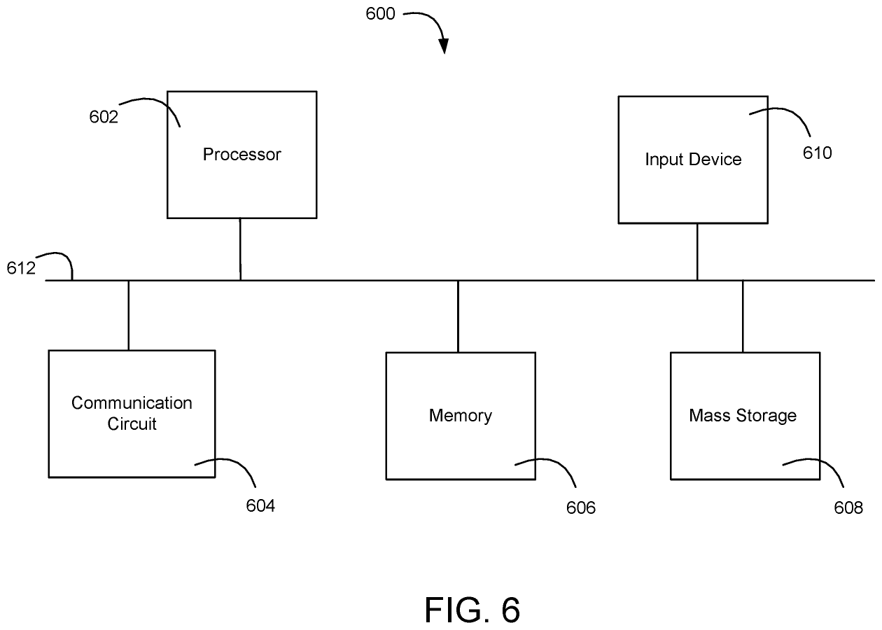

The systems, methods, and/or instrumentalities described herein may be implemented using one or more processors, one or more storage devices, and/or other suitable accessory devices such as display devices, communication devices, input/output devices, etc. FIG. 6 is a block diagram illustrating an example apparatus 600 that may be configured to perform the tasks described herein. As shown, apparatus 600 may include a processor (e.g., one or more processors) 602, which may be a central processing unit (CPU), a graphics processing unit (GPU), a microcontroller, a reduced instruction set computer (RISC) processor, application specific integrated circuits (ASICs), an application-specific instruction-set processor (ASIP), a physics processing unit (PPU), a digital signal processor (DSP), a field programmable gate array (FPGA), or any other circuit or processor capable of executing the functions described herein. Apparatus 600 may further include a communication circuit 604, a memory 606, a mass storage device 608, an input device 610, and/or a communication link 612 (e.g., a communication bus) over which the one or more components shown in the figure may exchange information.

Communication circuit 604 may be configured to transmit and receive information utilizing one or more communication protocols (e.g., TCP/IP) and one or more communication networks including a local area network (LAN), a wide area network (WAN), the Internet, a wireless data network (e.g., a Wi-Fi, 3G, 4G/LTE, or 5G network). Memory 606 may include a storage medium (e.g., a non-transitory storage medium) configured to store machine-readable instructions that, when executed, cause processor 602 to perform one or more of the functions described herein. Examples of the machine-readable medium may include volatile or non-volatile memory including but not limited to semiconductor memory (e.g., electrically programmable read-only memory (EPROM), electrically erasable programmable read-only memory (EEPROM)), flash memory, and/or the like. Mass storage device 608 may include one or more magnetic disks such as one or more internal hard disks, one or more removable disks, one or more magneto-optical disks, one or more CD-ROM or DVD-ROM disks, etc., on which instructions and/or data may be stored to facilitate the operation of processor 602. Input device 610 may include a keyboard, a mouse, a voice-controlled input device, a touch sensitive input device (e.g., a touch screen), and/or the like for receiving user inputs to apparatus 600.

It should be noted that apparatus 600 may operate as a standalone device or may be connected (e.g., networked, or clustered) with other computation devices to perform the functions described herein. And even though only one instance of each component is shown in FIG. 6, a skilled person in the art will understand that apparatus 600 may include multiple instances of one or more of the components shown in the figure.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. An apparatus, comprising:
one or more processors configured to:
obtain a medical image that depicts an object;
separate the medical image into a background layer and a foreground layer;
denoise the background layer using a first neural network;
denoise the foreground layer using a second neural network, wherein the second neural network differs from the first neural network with respect to at least one of a neural network architecture or a number of neural network parameters; and
merge the denoised background layer and the denoised foreground layer into a denoised medical image that depicts the object.

2. The apparatus of claim 1, wherein the one or more processors are configured to separate the medical image into the background layer and the foreground layer using a third neural network.

3. The apparatus of claim 2, wherein the third neural network is trained using training data generated via recursive projected compressive sensing.

4. The apparatus of claim 1, wherein the first neural network comprises a convolutional neural network and wherein the second neural network comprises a multi-layer perceptron (MLP) neural network.

5. The apparatus of claim 4, wherein the one or more processors being configured to denoise the foreground layer using the second neural network comprises the one or more processors being configured to dissect the foreground layer into multiple patches and denoise the multiple patches using the MLP neural network.

6. The apparatus of claim 1, wherein the first neural network comprises a smaller number of neural network parameters than the second neural network.

7. The apparatus of claim 1, wherein the one or more processors are configured to merge the denoised background layer and the denoised foreground layer using a third neural network.

8. The apparatus of claim 7, wherein the first neural network, the second neural network, and the third neural network are trained jointly.

9. The apparatus of claim 1, wherein the first neural network and the second neural network are trained jointly via a training process during which:
the first neural network is used to denoise a background training image comprising first synthetic noise;
the second neural network is used to denoise a foreground training image comprising second synthetic noise;
parameters of the first neural network are adjusted based on a difference between the denoised background training image and a clean ground truth background image; and
parameters of the second neural network are adjusted based on a difference between the denoised foreground training image and a clean ground truth foreground image.

10. The apparatus of claim 9, wherein, during the training process, the denoised foreground training image and the denoised background training image are merged into an output image, and the respective parameters of the first neural network and the second neural network are further adjusted based on a difference between the output image and a clean ground truth image.

11. The apparatus of claim 1, wherein the medical image is an X-ray image acquired via fluoroscopy imaging.

12. A method for image denoising, the method comprising:
obtaining a medical image that depicts an object;
separating the medical image into a background layer and a foreground layer;
denoising the background layer using a first neural network;
denoising the foreground layer using a second neural network, wherein the second neural network differs from the first neural network with respect to at least one of a neural network architecture or a number of neural network parameters; and
merging the denoised background layer and the denoised foreground layer into a denoised medical image that depicts the object.

13. The method of claim 12, wherein the medical image is separated into the background layer and the foreground layer using a third neural network, and wherein the third neural network is trained using training data generated via recursive projected compressive sensing.

14. The method of claim 12, wherein the first neural network comprises a convolutional neural network and wherein the second neural network comprises a multi-layer perceptron (MLP) neural network.

15. The method of claim 14, wherein denoising the foreground layer using the second neural network comprises dissecting the foreground layer into multiple patches and denoising the multiple patches using the MLP neural network.

16. The method of claim 12, wherein the first neural network comprises a smaller number of neural network parameters than the second neural network.

17. The method of claim 12, wherein denoised background layer and the denoised foreground layer are merged into the denoised medical image using a third neural network, and wherein the first neural network, the second neural network, and the third neural network are trained jointly.

18. The method of claim 12, wherein the first neural network and the second neural network are trained via a training process during which:
the first neural network is used to denoise a background training image comprising first synthetic noise;
the second neural network is used to denoise a foreground training image comprising second synthetic noise;
parameters of the first neural network are adjusted based on a difference between the denoised background training image and a clean ground truth background image; and
parameters of the second neural network are adjusted based on a difference between the denoised foreground training image and a clean ground truth foreground image.

19. The method of claim 18, wherein, during the training process, the denoised foreground training image and the denoised background training image are merged into an output image, and the respective parameters of the first neural network and the second neural network are further adjusted based on a difference between the output image and a clean ground truth image.

20. A non-transitory computer-readable medium comprising instructions that, when executed by one or more processors included in a computing device, cause the one or more processors to implement the method of claim 12.
